(19) United States
(12) Patent Application Publication
(10) Pub. No.: US 2007/0192652 A1
(43) Pub. Date: Aug. 16, 2007

(54) Restricting devices utilizing a device-to-server heartbeat

(75) Inventors: Sandy Kao, Austin, TX (US); Rodrigo J. Pastrana, Delray Beach, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 11/354,477

(22) Filed: Feb. 14, 2006

(51) Int. Cl. G06F 11/00

(52) U.S. Cl. 714/4

(57) ABSTRACT

A method of automatically locking a client can include a step of a client automatically establishing a heartbeat interval. A determination can be automatically made regarding whether a proper server response is received within the heartbeat interval. When no proper response is received, the client can be automatically placed in a locked state. All client functions accessible by a user other than those functions relating to unlocking the client can be disabled while the client is in the locked state. A remotely located server can unlock the client by conveying an unlock message to the client.

### BACKGROUND

1. Field of the Invention

The present invention relates to the field of computer security, and, more particularly, to restricting computing devices utilizing a device-to-server heartbeat.

2. Description of the Related Art

Businesses are increasingly relying upon computing devices to perform business tasks. For example, in addition to desktop computers, businesses often provide mobile telephones, personal data assistants (PDAs), bar code scanners, tablet computing devices, notebooks, kiosks, and other devices for use by customers and employees. Individual ones of these devices are often shared between employees and/or customers. These devices are often portable devices that are optimally placed in locations of high availability.

The cost and availability of the devices result in a high risk of theft. Theft of the devices usually has one of three different goals: (1) to personally use a stolen device, (2) to resell the stolen device, and (3) to extract sensitive information from the stolen device. Conventional techniques to prevent device theft have significant shortcomings.

For example, it is common to physically constrain a device to a location using a chain/lock combination. This solution can greatly restrict the placement and mobility of a device, which decreases its usefulness in a business setting. Also, physical security precautions can require active measures be taken by employee users, which are often ignored or forgotten.

Other security solutions attempt to restrict, locate, or disable a device after a theft has been detected. For example, software can be loaded and hidden on the device that causes the device to broadcast a beacon or to take a restrictive action responsive to a command received via the Internet. These post theft solutions are flawed since each requires the stolen device to be able to receive commands via a network. Conventional software-based theft deterrents are also able to be removed from a device by a device user. For these reasons, conventional anti-theft solutions are inadequate to prevent device thefts. That is, even when conventional anti-theft solutions are implemented, the goals of most device thieves can still be achieved.

### SUMMARY OF THE INVENTION

The present invention executes a daemon or application upon a computing device that generates a heartbeat for the device. The heartbeat is associated with a timer and a timed operation interval, referred to as a heartbeat interval. The device can be used in a stand-alone as well as in a networked fashion for the heartbeat interval. Before the end of the interval, the device requires a heartbeat response from a remotely located server. Otherwise, the device is automatically locked.

In different embodiments, the device can actively request a heartbeat response by sending an initial heartbeat request message to the server, or the device can passively receive non-prompted heartbeat responses from the server. Either way, the received heartbeat response can permit the device to operate for an additional interval. Shifting the device from a locked state back to an unlocked state can require the receipt of an unlock command from a remotely located server. Accordingly, the device is unable to be utilized for any significant duration unless it is able to periodically receive heartbeat responses from one or more remotely located servers.

The present invention can be implemented in accordance with numerous aspects consistent with material presented herein. For example, one aspect of the present invention can include a method for automatically locking a client. The method can include a step of a client automatically establishing a heartbeat interval. A determination can be automatically made regarding whether a proper server response is received within the heartbeat interval. When no proper response is received, the client can be automatically placed in a locked state. All client functions accessible by a user other than those functions relating to unlocking the client can be disabled while the client is in the locked state. A remotely located server can unlock the client by conveying an unlock message to the client.

Another aspect of the present invention can include a method of restricting access to a computing device. The method can automatically generate a heartbeat event within a client. A determination can be made as to whether a server response is received by the client for the heartbeat event. The lock state of the client can be automatically altered based upon the determining step. In the method, a server response to the heartbeat event can be required to prevent the client from automatically entering a locked state.

Still another aspect of the present invention can include a storage space upon a machine-readable medium local to a client. The machine-readable medium can include code instructions for causing a machine to identify a heartbeat interval. A heartbeat timer can be started within the client. When a heartbeat response is received from a remotely located server, the heartbeat timer can be reset. When the heartbeat timer exceeds the heartbeat interval, the client can be automatically adjusted from an unlocked state to a locked state. All client functions accessible by a user other than those functions relating to unlocking the client can be disabled while the client is in the locked state.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for restricting devices using a heartbeat in accordance with an embodiment of the inventive arrangements disclosed herein.

FIG. 2 is a flow chart of a method for restricting devices using a heartbeat in accordance with an embodiment of the inventive arrangements disclosed herein.

FIG. 3 is a flow chart of a method in which a service agent can configure a system to implement a heartbeat that restricts client devices in accordance with an embodiment of the inventive arrangements disclosed herein.

### DETAILED DESCRIPTION OF THE INVENTION

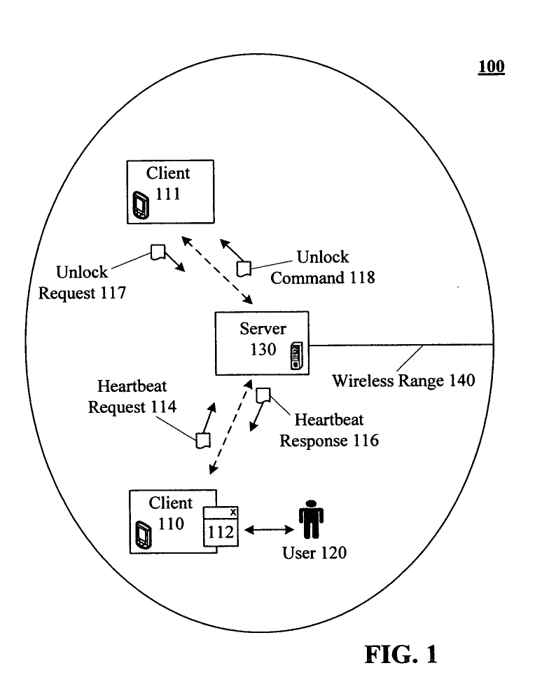

FIG. 1 is a schematic diagram of a system 100 for restricting devices using a heartbeat in accordance with an embodiment of the inventive arrangements disclosed herein. System 100 can include a client 110 and a client 111, each of which requires a periodic heartbeat response 116 from server 130 to prevent the client 110-111 from automatically entering a locked state. When in a locked state, the client 110-111 is unable to be utilized as intended by user 120 for any purpose other than attempting to unlock the client 110-111.

In one embodiment, data contained within client 110-111 can be secured when the client 110-111 enters a locked state. For example, data can be automatically deleted or shredded when the client 110-111 is locked. In another example, all data within the client 110-111 can be automatically encrypted when the client 110-111 enters a locked state. The data can be automatically decrypted, when the client 110-111 is placed in an unlocked state.

If data within client 110-111 is particularly sensitive, software can be installed that establishes an encrypted drive, where by default data within the drive is encrypted. When active or unlocked, a decryption key, stored in non-persistent memory such as RAM, can be used to dynamically decrypt data contained within the encrypted drive. Accordingly, accessing unencrypted data requires an affirmative step, which can only be performed when the client 110-111 is unlocked.

The client 110-111 can be any computing device upon which a heartbeat application 112 can be installed. The client 110-111 can include, but is not limited to, a computer, a personal data assistant (PDA), a mobile telephone, a laptop computer, a bar-code scanner, a media player, a wearable computing device, and other such computing devices. The client 110-111 can be configured so that user 120 is unable to remove the heartbeat application 112 from the client 110-111. The user 120 is also unable to prevent the heartbeat application 112 from entering a locked state in the absence of periodically received heartbeat responses 115 from server 130.

The heartbeat application 112 can establish a heartbeat interval and can include a heartbeat timer. Whenever the heartbeat timer exceeds the heartbeat interval, the client 110-111 can enter the locked state. The heartbeat response 116 can be used to reset the heartbeat timer. In one embodiment, the client 110-111 can actively solicit the server 130 for a heartbeat response 116 by conveying one or more heartbeat requests 114. In another embodiment, server 130 can broadcast or automatically convey heartbeat responses 116 to client 110-111 without an explicit heartbeat request 114 being made.

The heartbeat application 112 can be implemented within hardware, firmware, and/or software of the client 110-111. The heartbeat application 112 can be a daemon or background application executing on client 110 to which user 120 is not granted write, modify, or delete privileges. Heartbeat application 112 can also be a firmware or hardware based security process that can disable a critical portion of the client 110-111 when locked. For example, the heartbeat application 112 can disable all input/output ports other than a communication port to the server, when locked.

In one embodiment, the heartbeat application 112 can include a custom restriction profile. The profile can include one or more parameters that are able to be customized by an authorized individual. For example, a system administrator can change a heartbeat interval using the custom restriction profile. In another example, user 120 can modify the custom restriction profile to change the frequency with which heartbeat requests 114 are generated.

The heartbeat response 116 can include any type of message capable of resetting the heartbeat timer. It is common for the heartbeat response 116 to be implemented as a secure key or an encrypted pass code that is difficult for unauthorized users 120 to duplicate or ascertain. For example, the heartbeat response 116 can be implemented as a digital certificate. The heartbeat response 116 can also be implemented as one part of a public-private key combination, where a complimentary part is known by client 110-111. Conventional security practices and technologies can be utilized in conjunction with the heartbeat concept disclosed herein to ensure the heartbeat application 112 and automatic locking functions of the client 110-111 are not easily circumvented.

Server 130 can be any computing device capable of transmitting a heartbeat response 116 to the client 110-111. For example, server 130 can be a computer that receives heartbeat requests 114 from the client 110-111. Each heartbeat request 114 can include authorizing information, such as user 120 identification and password. The server 130 can determine whether user 120 is authorized to utilize client 110-111. If the use of client 110-111 by user 120 is authorized, the server 130 can convey a heartbeat response 116 to the client 110-111. For security reasons, system 100 can be configured so that heartbeat responses 116 expire, meaning that new and different heartbeat responses 116 are necessary after a designated time.

Once a client 110-111 has been locked, server 130 can generate an unlock command 118, which alters the lock state of the client 110-111. The unlock command 118 can be either generated responsive to an unlock request 117 or can be automatically generated by the server 130. While the unlock command 118 can be different from the heartbeat response 116, embodiments are contemplated where a single message from server 130 can function as both heartbeat response 116 and unlock command 118.

Server 130 can be communicatively linked to client 110-111 in any fashion that permits the exchange of digitally encoded information between the server 130 and the client 110-111. For example, the client 110-111 can be linked to server 130 through a network, which can be line-based or wireless. Information can be exchanged using any known communication protocol, such as Transmission Control Protocol/Internet Protocol (TCP/IP) based protocols, Universal Serial Bus (USB) protocols, BLUETOOTH protocols, Universal Plug and Play (UPnP) protocols, and the like.

In a common embodiment, server 130 and client 110-111 will communicate via a wireless communication system that has a limited range, denoted by wireless range 140. Range 140 can be centered upon one or more wireless transceivers. For example, when server 130 is wirelessly linked to client 110-111 through an 802.11 based protocol, the server can function as a wireless access point. In another example, multiple wireless transceivers can be established and combined to form any desired wireless range 140.

When outside the wireless range 140, client 110-111 can be unable to automatically communicate with server 130 and will therefore be unable to receive a heartbeat response 116 from the server 130. Consequently, the client 110-111 will enter a locked state. When a locked client 110-111 reenters the wireless range 140, the client 110-111 can receive the unlock command 118 from server 130. Thus, geographic boundaries in which clients 110-111 can be used are able to be established based upon a wireless communication range 140.

In one embodiment, system 100 can be implemented using a server 130 with robust authorization and transmission capabilities or using a server 130 with extremely limited computing resources. For example, server 130 can be implemented as a broadcasting beacon that intermittently broadcasts a key. The key can function as both heartbeat response 116 and unlock command 118. When clients 110-111 are outside the broadcast range of the beacon, no heartbeat response 116 is being received, which can cause the clients 110-111 to be placed in a locked state.

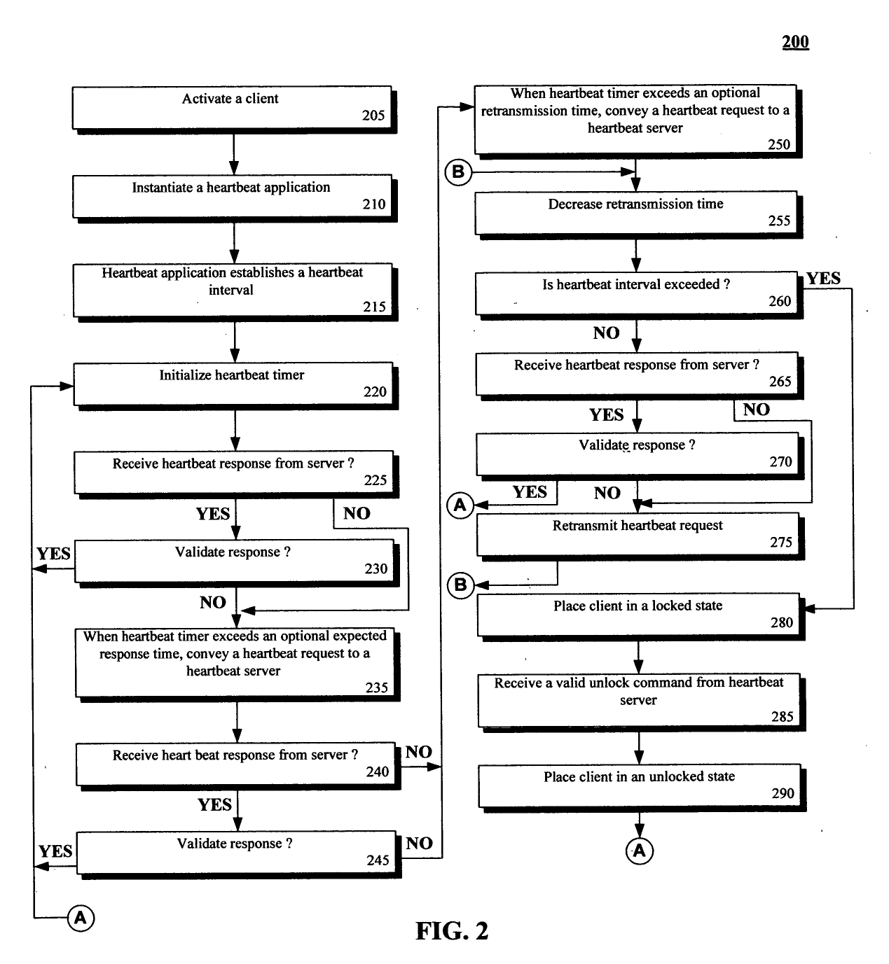

FIG. 2 is a flow chart of a method 200 for restricting devices using a heartbeat in accordance with an embodiment of the inventive arrangements disclosed herein. In one embodiment, the method 200 can be performed in the context of system 100.

Method 200 can begin in step 205, where a client is activated. Activation of a client can occur when the client is powered on. In step 210, a heartbeat application can be executed upon the client. In one arrangement, the instantiation of the heartbeat application can occur in a non-preemptable fashion, such as occurring as a Power On Self Test (POST) step of the client. In step 215, the heartbeat application can establish a heartbeat interval. In step 220, a heartbeat timer can be initialized.

In step 225, a check can be performed to see if the client has received a heartbeat response from a server. If so, the method can proceed to step 230 where the response can be validated. If the response is validated, the method can loop to step 220, where the heartbeat timer can be reset. If no heartbeat response is received or if a received heartbeat response is not valid, the method can proceed to step 235.

In step 235, an optional expected response time can be implemented. The expected response time can be a time limit less than the heartbeat interval that causes a heartbeat request to be issued from the client to a server. The server can be configured to respond to heartbeat requests with heartbeat responses when the heartbeat requests are issued by a valid user and when the client is communicatively linked to (or within a communication range of) the server.

In step 240, another check can be performed for the heartbeat response. When a response is received, the response can be validated, as shown in step 245. A valid response causes the method to loop to step 220, where the heartbeat timer is reset. Otherwise, the method proceeds to step 250.

In step 250, an optional retransmission time can be implemented. The retransmission time can result in another heartbeat request being conveyed to the server. The retransmission time can be continuously decreased for each retransmission iteration, as shown by step 255. Thus, clients can more frequently issue heartbeat requests as the heartbeat timer approaches the heartbeat interval.

In step 260, if the heartbeat interval is exceeded, the method can branch to step 280, where the client is placed in a locked state. If the heartbeat interval is not exceeded, the method can progress from step 260 to step 265. In step 265, a check for a heartbeat response can be performed. A received response can be validated in step 270. If a valid heartbeat response is received, the method can loop from step 270 to step 220, where the heartbeat timer is reset. If no valid heartbeat response is received, the method can progress to step 275, where the heartbeat request can be retransmitted. The method can loop from step 275 to step 255.

Once the client has been placed in a locked state (step 280), the client can remain in that locked state until a valid unlock command is received (step 285). In step 290, the unlock command can place a client in an unlocked state. Upon entering the unlocked state, a new heartbeat timer can be initialized for the client. Hence, the method can loop from step 290 to step 220.

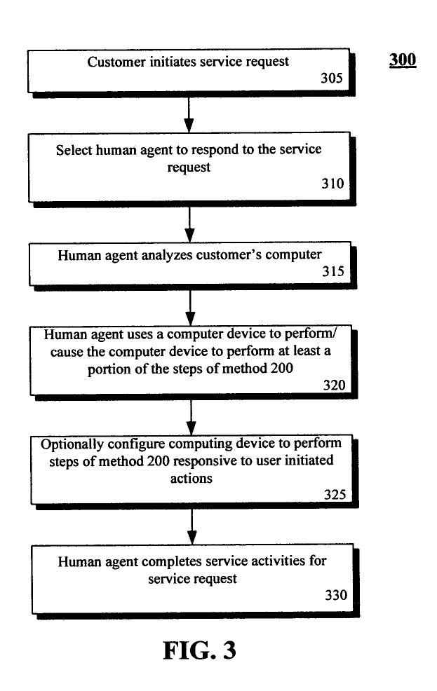

FIG. 3 is a flow chart of a method 300 in which a service agent can configure a system to implement a heartbeat that restricts client devices in accordance with an embodiment of the inventive arrangements disclosed herein. Method 300 can be preformed in the context of system 100.

Method 300 can begin in step 305, when a customer initiates a service request. The service request can be a request for a service agent to configure a new system, such as system 100, for the client. The service request can also be a request to troubleshoot a problem with a client access system. For example, the service request can be a request to unlock a currently locked client, which is not responding to an unlock command issued by a heartbeat server.

In step 310, a human agent can be selected to respond to the service request. In step 315, the human agent can analyze a customer's current system and can develop a solution. The solution can include the acquisition and deployment of additional hardware, such as deployment of one or more heartbeat servers and/or wireless access points for wireless communication with a heartbeat server.

In step 320, the human agent can use one or more computing devices to perform or to cause the computer device to perform the steps of method 200. For example, the agent can utilize agent specific software/hardware that functions as a skeleton or master key to unlock a locked device (steps 285, 290).

In optional step 325, the human agent can configure the customer's computer in a manner that the customer or clients of the customer can perform one or more steps of method 200 in the future. For example, the service agent can load and configure a heartbeat server and can deploy heartbeat applications upon customer owned client machines so that the clients and server automatically perform steps 210-290. In step 330, the human agent can complete the service activities.

It should be noted that while the human agent may physically travel to a location local to adjust the customer's computer or application server, physical travel may be unnecessary. For example, the human agent can use a remote agent to remotely manipulate the customer's heartbeat server or a customer owned client.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method of automatically locking a client comprising:
a client automatically establishing a heartbeat interval;
automatically determining whether a proper server response is received within the heartbeat interval; and
when no proper response is received, automatically placing the client in a locked state, wherein all client functions accessible by a user other than those functions relating to unlocking the client are disabled while the client is in the locked state, and wherein unlocking the client requires a remotely located server to provide an unlock message to the client.

2. The method of claim 1, wherein the placing step further comprises:
automatically securing data contained within the client so that the secured data is not accessible while the client is in a locked state.

3. The method of claim 1, wherein the client and the remotely located server both include a wireless communication ability, wherein messages including the server response and the unlock message are wirelessly exchanged between the client and the remotely located server.

4. The method of claim 1, wherein a communication range is established within which the client is able to become communicatively linked to a server configured to provide heartbeat responses to at least one client to prevent the at least one client from entering a locked state, wherein the client is unable to receive the proper server response when located outside the communication range.

5. The method of claim 4, wherein the communication range is based upon a range of a wireless communication network to which the server is communicatively linked.

6. The method of claim 1, wherein said steps of claim 1 are performed by at least one machine in accordance with at least one computer program having a plurality of code sections that are executable by the at least one machine.

7. The method of claim 1, wherein the steps of claim 1 are performed by at least one of a service agent and a computing device manipulated by the service agent, the steps being performed in response to a service request.

8. A method of restricting access to a computing device comprising:
automatically generating a heartbeat event within a client;
determining whether a server response is received by the client for the heartbeat event; and
automatically altering a lock state of the client based upon the determining step, wherein a server response to the heartbeat event is required to prevent the client from automatically adjusting from an unlocked state to a locked state.

9. The method of claim 8, further comprising:
establishing a custom restriction profile upon the client, wherein the determining step is based upon the restriction profile.

10. The method of claim 9, further comprising:
authenticating a user for the client; and
ascertaining that the user possesses privileges to modify the custom restriction profile, wherein the client includes an interface through which the authenticated user is able to configure the custom restriction profile.

11. The method of claim 8, wherein the altering step alters the lock state of the client to a locked state, and wherein the client is configured to remain in the locked state until a communication pathway is established between the client and the server and until the server provides an unlock response to the client via the communication pathway.

12. The method of claim 11, wherein the client iteratively polls the server to receive the unlock response.

13. The method of claim 11, wherein all client functions accessible by a user other than those functions relating to unlocking the client are disabled while the client is in the locked state.

14. The method of claim 8, further comprising:
responsive to the heartbeat event, the client automatically attempting to wirelessly transmit a heartbeat message to which the server response is expected, wherein the server response prevents the client from automatically adjusting from the unlocked state to the locked state.

15. The method of claim 14, further comprising:
identifying an expected response time and a retransmission time, wherein the retransmission time is less than the expected response time;
when the client fails to receive the server response to the heartbeat message within the expected response time, the client retransmitting the heartbeat message; and
when the client fails to receive the server response to the retransmitted heartbeat message within the retransmission time, the client executing at least one of the altering step and a step of again retransmitting the heartbeat message.

16. The method of claim 8, wherein said steps of claim 8 are performed by at least one machine in accordance with at least one computer program having a plurality of code sections that are executable by the at least one machine.

17. The method of claim 8, wherein the steps of claim 8 are performed by at least one of a service agent and a computing device manipulated by the service agent, the steps being performed in response to a service request.

18. A storage space upon a machine-readable medium local to a client, the machine-readable medium comprising a plurality of code instructions for causing a machine to perform the steps of:
identifying a heartbeat interval;
starting a heartbeat timer within the client;
when a heartbeat response is received from a remotely located server, resetting the heartbeat timer; and
when the heartbeat timer exceeds the heartbeat interval, automatically adjusting the client from an unlocked state to a locked state, wherein all client functions accessible by a user other than those functions relating to unlocking the client are disabled while the client is in the locked state.

19. The storage space of claim 18, wherein the client is configured so that a user of the client is unable to disable the heartbeat timer and is unable to prevent the client from entering the locked state in absence of a heartbeat response being received from the remotely located server.

20. The storage space of claim 18, wherein the identifying, starting, and adjusting steps are performed as a background process executing upon the client, wherein users of the device are not authorized to remove the background process and are not authorized to disable the background process.
